(19) United States
(12) Patent Application Publication
(10) Pub. No.: US 2007/0266039 A1
(43) Pub. Date: Nov. 15, 2007

(54) Simplifying A Visual Depiction of A Graph

(76) Inventors: James R. Boykin, Pflugerville, TX (US); Alberto Giammaria, Austin, TX (US); Brian J. Schlosser, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/382,755

(22) Filed: May 11, 2006

(51) Int. Cl. G06F 7/00

(52) U.S. Cl. 707/102

(57) ABSTRACT

Methods, apparatus, and products are disclosed for simplifying a visual depiction of a graph by identifying a node for removal from the visual depiction of the graph, the node having at least two relationships with at least one remaining node, removing the node identified for removal, and creating a virtual relationship for the at least one remaining node in dependence upon the removed node's relationships with the at least one remaining node.

### BACKGROUND OF THE INVENTION

1. Field of the Invention

The field of the invention is data processing, or, more specifically, methods, apparatus, and products for simplifying a visual depiction of a graph.

2. Description of Related Art

Architects often use computers to model components of a system that may represent a computer network, a manufacturing process, computer software, a company hierarchy, a sports league, electronic circuit, entities, and so on. The components and the relationships among components of a system are typically modeled using graphs composed of nodes and the relationships among those nodes. Nodes represent the components of the system, while the relationships among the nodes represent the relationships among the components.

In a graph with many nodes and relationships, the complexity of the graph typically increases and size of the graph often becomes extremely large. Such a large and complex graph is not only difficult to understand, but also difficult or impossible to render on the finite screen area of a display device. A current solution for making a large and complex graph more understandable and providing the ability to render a large and complex graph on a display device is to filter some of the nodes of the graph. Filtering a node from a graph eliminates the node from a visual depiction of the graph. Filtering the nodes of the graph, however, often eliminates more information about the graphed system than necessary such as, for example, the relationships between the filtered nodes.

### SUMMARY OF THE INVENTION

Methods, apparatus, and products are disclosed for simplifying a visual depiction of a graph by identifying a node for removal from the visual depiction of the graph, the node having at least two relationships with at least one remaining node, removing the node identified for removal, and creating a virtual relationship for the at least one remaining node in dependence upon the removed node's relationships with the at least one remaining node.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in simplifying a visual depiction of a graph according to embodiments of the present invention.

FIG. 2 sets forth a flow chart illustrating an exemplary method for simplifying a visual depiction of a graph according to embodiments of the present invention.

FIG. 3 sets forth a flow chart illustrating a further exemplary method for simplifying a visual depiction of a graph according to embodiments of the present invention.

FIG. 4 sets forth a flow chart illustrating a further exemplary method for simplifying a visual depiction of a graph according to embodiments of the present invention.

FIG. 5 sets forth a flow chart illustrating a further exemplary method for simplifying a visual depiction of a graph according to embodiments of the present invention.

FIG. 6 sets forth a flow chart illustrating a further exemplary method for simplifying a visual depiction of a graph according to embodiments of the present invention.

FIG. 7 sets forth a flow chart illustrating a further exemplary method for simplifying a visual depiction of a graph according to embodiments of the present invention.

### DETAILED DESCRIPTION OF EXEMPLARY EMBODIMENTS

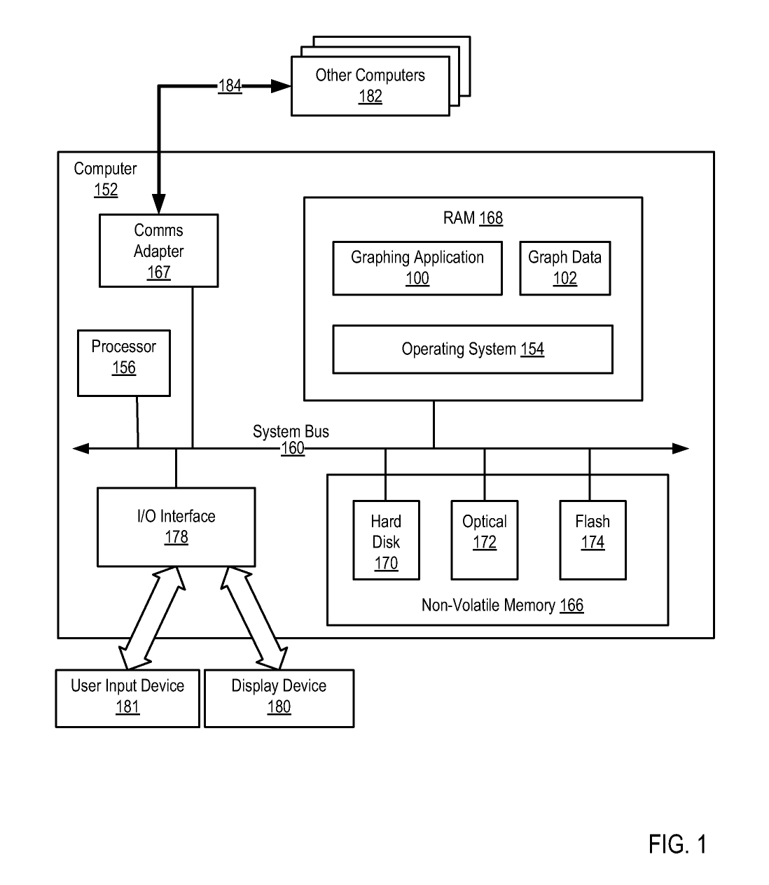

Exemplary methods, apparatus, and products for simplifying a visual depiction of a graph according to embodiments of the present invention are described with reference to the accompanying drawings, beginning with FIG. 1. Simplifying a visual depiction of a graph in accordance with the present invention is generally implemented with computers, that is, with automated computing machinery. FIG. 1, therefore, sets forth a block diagram of automated computing machinery comprising an exemplary computer (152) useful in simplifying a visual depiction of a graph according to embodiments of the present invention.

A graph is a set of nodes and a set of relationships among those nodes. The relationships among nodes are often referred to as ‘edges.’ A node of a graph represents an object such as, for example, a system, a component, a location, a process, a step, and so on. Each node of a graph may have attributes associated with the node that define characteristics of the node such as, for example, the node's label, type, color, shape, and so on. The number of nodes in a graph specifies the order of the graph. For example, a graph having three nodes has an order of ‘3.’

Each relationship among the nodes has two ‘endpoints’ in the set of nodes of a graph. The endpoints of a relationship may be two distinct nodes in the set of nodes, or the endpoints of a relationship may be the same node in the set of nodes. When the endpoints of a relationship are the same node in the set of nodes, the relationship is referred to as a ‘loop.’ Each relationship of a graph may have attributes associated with the relationship that define characteristics of the relationship such as, for example the relationship's label, type, color, shape, and so on. The number of relationships in a graph specifies the size of a graph. For example, a graph having two relationships has a size of ‘2.’

In the system of FIG. 1, the computer (152) includes at least one computer processor (156) or ‘CPU’ as well as random access memory (168) (‘RAM’) which is connected through a system bus (160) to processor (156) and to other components of the computer. Stored in RAM (168) is a graphing application (100). The graphing application (100) is a set of computer program instructions improved for simplifying a visual depiction of a graph according to embodiments of the present invention. The graphing application (100) operates generally for simplifying a visual depiction of a graph according to embodiments of the present invention by identifying a node for removal from the visual depiction of the graph, the node having at least two relationships with at least one remaining node, removing the node identified for removal, and creating a virtual relationship for the at least one remaining node in dependence upon the removed node's relationships with the at least one remaining node. Examples of graphing applications that may be improved for simplifying a visual depiction of a graph according to embodiments of the present invention may include Graphviz by AT&T Information Visualizaiton Research Group, aiSee 2.2.11 by AbsInt Angewandte Informatik GmbH, or Graphlet 5.0.1 by BRAINSYS Informatiksysteme GmbH.

In the system of FIG. 1, graph data (102) is also stored in RAM (168). Graph data (102) represents the nodes, the relationships, and the attributes of the nodes and the relationships of a graph. Graph data (102) may represent a graph using a graphing description language. Examples of graphing description languages that may be improved for simplifying a visual depiction of a graph according to embodiments of the present invention may include the Graph Description Language (‘GDL’) or the Graph Modeling Language (‘GML’). The GDL represents a graph using ASCII text that describes the graph in terms of nodes, edges, and attributes. Attributes describe the nodes and edges of a graph. An example graph having an order of ‘2’ and size of ‘1’ may be represented using the GDL as follows:

```
graph: {
    node: { title: “node1” }
    node: { title: “node2” }
    edge: { source: “node1” target: “node2”}
}
```

The example above describes a graph that includes a node having a value of ‘node1’ for the ‘title’ attribute and another node having a value of ‘node2’ for the ‘title’ attribute. The graph also includes a relationship called an ‘edge.’ The edge has a value of ‘node1’ for the ‘source’ attribute and a value of ‘node2’ for the ‘target’ attribute. That is, the edge describes a relationship between the nodes identified by values of ‘node1’ and ‘node2’ for ‘title’ attribute of the nodes. The ‘source’ and ‘target’ attributes of the relationship represent the endpoints of the relationship in the GDL.

The GML also represents a graph using ASCII text. The GML consists of key-value pairs to describe the graph in terms of nodes, edges, and attributes. An example graph having an order of ‘2’ and size of ‘1’ may be represented using the GML as follows:

```
graph [
    node [ id 1 ]
    node [ id 2 ]
    edge [ source 1
        target 2 ]
    ]
```

The example above describes a graph that includes a node having a value of ‘1’ for the ‘id’ attribute and another node having a value of ‘2’ for the ‘id’ attribute. The graph also includes a relationship called an ‘edge.’ The edge has a value of ‘1’ for the ‘source’ attribute and a value of ‘2’ for the ‘target’ attribute. That is, the edge describes a relationship between the nodes identified by values of ‘1’ and ‘2’ for ‘id’ attribute of the nodes. As in the GDL, the GML also represents the endpoints of a relationship using the ‘source’ and ‘target’ attributes.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), graphing application (100), and graph data (102) in the example of FIG. 1 are shown in RAM (168), but many components of such software typically are stored in non-volatile memory (166) also.

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice. In the example computer of FIG. 1, display devices (180) display visual depictions of a graph.

The exemplary computer (152) of FIG. 1 includes a communications adapter (167) for implementing data communications (184) with other computers (182). Such data communications may be carried out serially through RS-232 connections, through external buses such as the Universal Serial Bus (‘USB’), through data communications networks such as Internet Protocol (‘IP’) networks, and in other ways as will occur to those of skill in the art. Communications adapters implement the hardware level of data communications through which one computer sends data communications to another computer, directly or through a network. Examples of communications adapters useful for simplifying a visual depiction of a graph according to embodiments of the present invention include modems for wired dial-up communications, Ethernet (IEEE 802.3) adapters for wired network communications, and 802.11b adapters for wireless network communications.

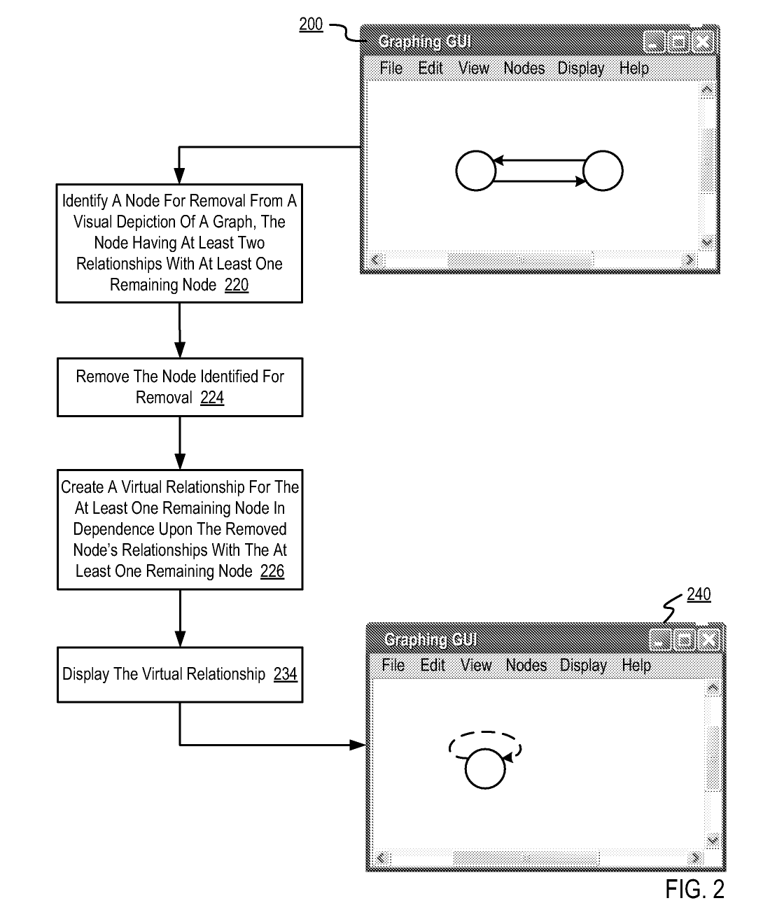

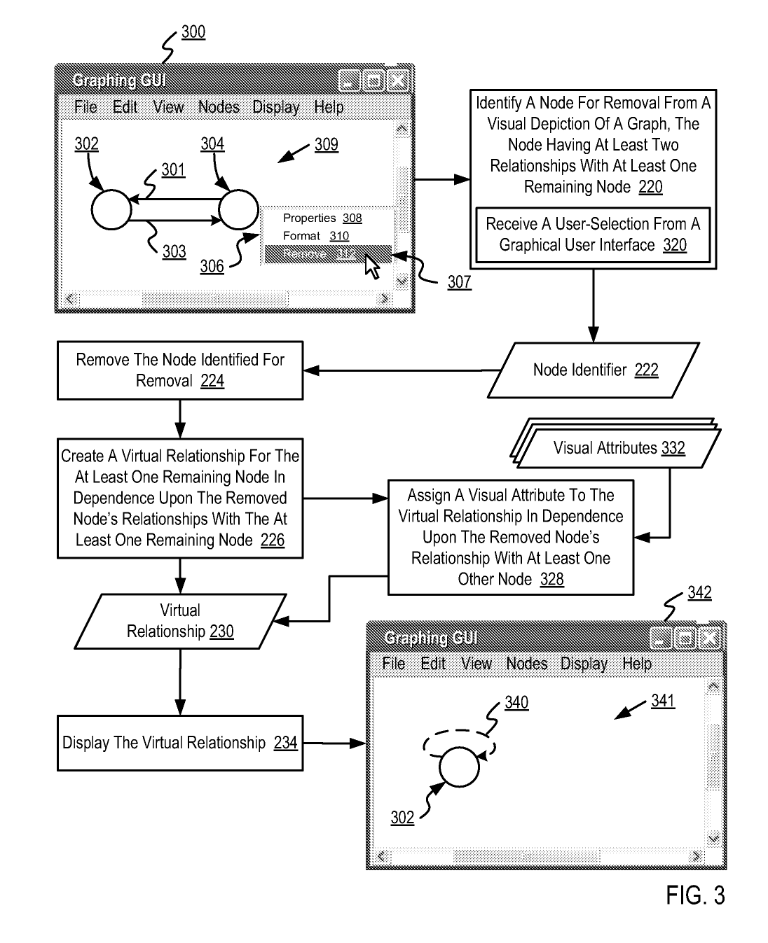

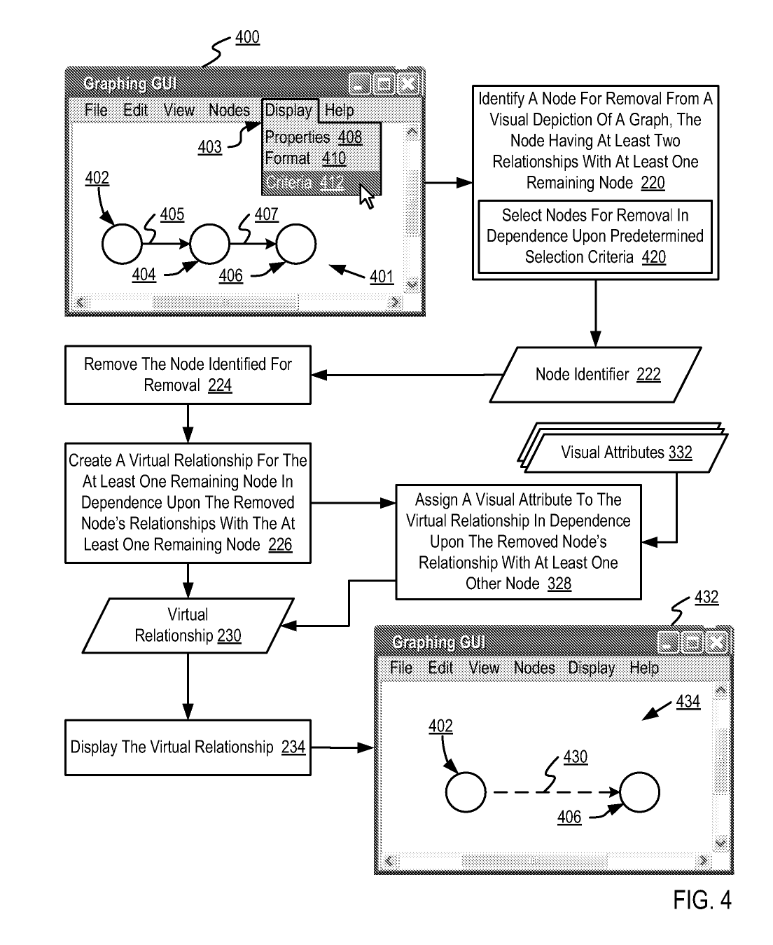

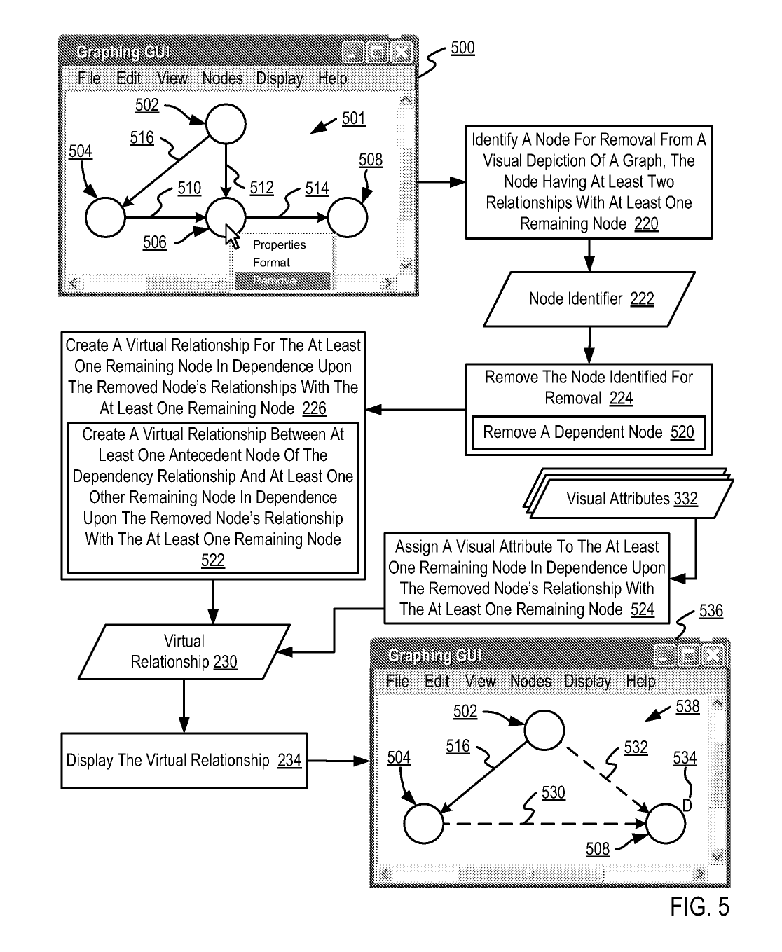

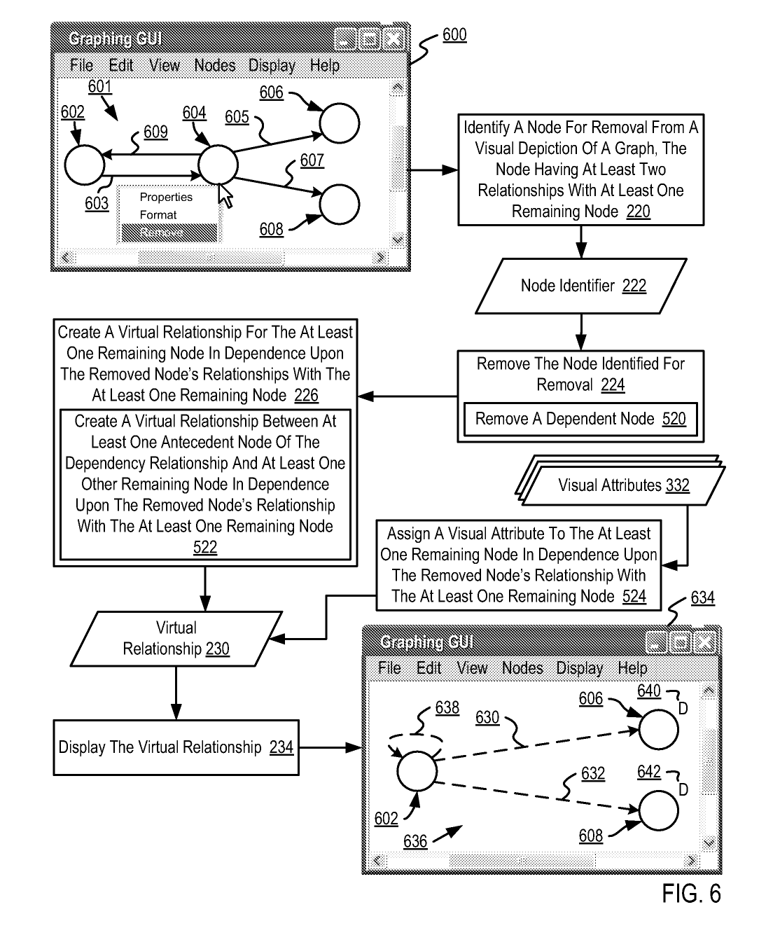

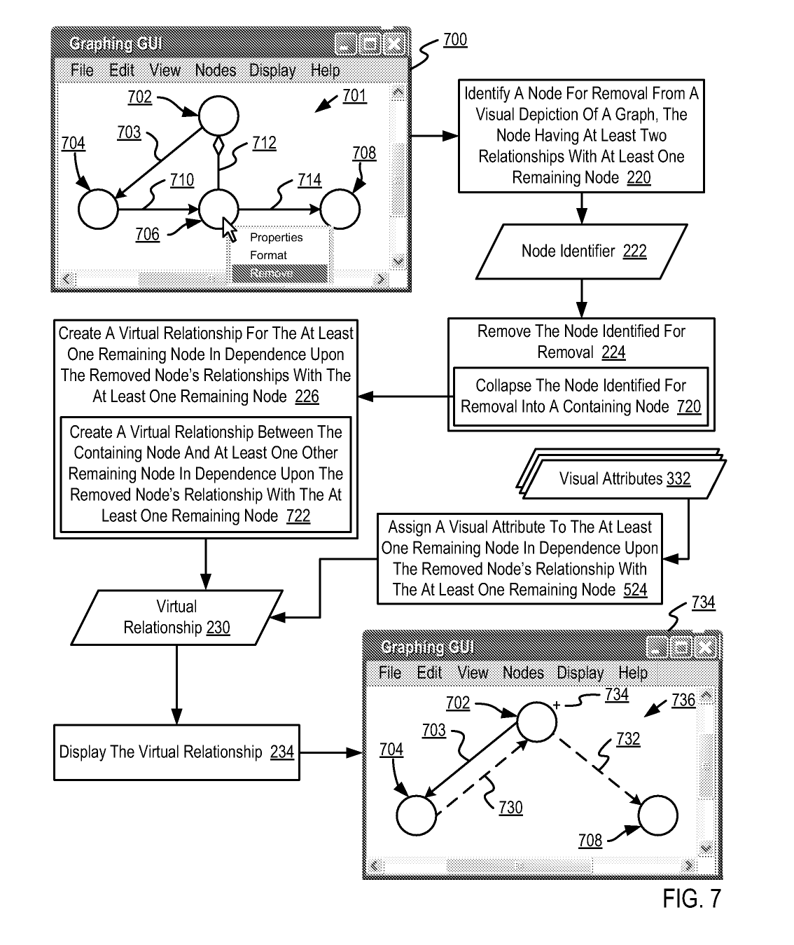

For further explanation, FIG. 2 sets forth a flow chart illustrating an exemplary method for simplifying a visual depiction of a graph according to embodiments of the present invention that includes identifying (220) a node for removal from a visual depiction of a graph and that has at least two relationships with at least one remaining node. Identifying (220) a node for removal from the visual depiction of the graph, the node having at least two relationships with at least one remaining node according to the method of FIG. 2 may be carried out by receiving a user-indication from a graphical user interface (‘GUI’) such as, for example, the graphing GUI (200), or selecting nodes for removal in dependence upon predetermined selection criteria as discussed below with reference to FIGS. 3 and 4. In the example of FIG. 2, the node identified for removal may be implemented as a dependent node in a dependency relationship with at least one other node and having at least one other relationship with at least one other node as discussed below with reference to FIGS. 5 and 6. The node identified for removal may also be implemented as a contained node in a containment relationship with a containing node as discussed below with reference to FIG. 7.

The method of FIG. 2 also includes removing (224) the node identified for removal. Removing (224) the node identified for removal may be carried out by removing the dependent node or by collapsing the node identified for removal into the containing node as discussed below with reference to FIGS. 5, 6, and 7.

The method of FIG. 2 also includes creating (226) a virtual relationship for the at least one remaining node in dependence upon the removed node's relationships with the at least one remaining node. A virtual relationship (230) is a new relationship for at least one remaining node that replaces at least two relationships of the removed node while maintaining information about the replaced relationships and often information about the removed node.

Creating (226) a virtual relationship for the at least one remaining node in dependence upon the removed node's relationships with the at least one remaining node may be carried out by creating a virtual relationship between at least one antecedent node of the dependency relationship and at least one other remaining node in dependence upon the removed node's relationship with the at least one remaining node as discussed below with reference to FIGS. 5 and 6. Creating a virtual relationship between at least one antecedent node of the dependency relationship and at least one other remaining node in dependence upon the removed node's relationship with the at least one remaining node advantageously operates to simplify a visual depiction of a graph that includes nodes in a dependency relationships.

Creating (226) a virtual relationship for the at least one remaining node in dependence upon the removed node's relationships with the at least one remaining node may also be carried out by creating a virtual relationship between the containing node and at least one other remaining node in dependence upon the removed node's relationship with the at least one remaining node as discussed below with reference to FIG. 7. Creating a virtual relationship between the containing node and at least one other remaining node in dependence upon the removed node's relationship with the at least one remaining node advantageously operates to simplify a visual depiction of a graph that includes nodes in a containment relationships.

The method of FIG. 2 also includes displaying (234) a virtual relationship. Displaying (234) the virtual relationship according to the method of FIG. 2 may be carried out by displaying the virtual relationship using a GUI such as, for example, the graphing GUI (240).

As discussed above with reference to FIG. 2, identifying a node for removal from the visual depiction of the graph may be carried out by receiving a user-indication from a GUI. For further explanation, therefore, FIG. 3 sets forth a flow chart illustrating a further exemplary method for simplifying a visual depiction of a graph according to embodiments of the present invention that includes identifying (220) a node for removal from a visual depiction (309) of a graph that is carried out by receiving (320) a user-indication from a GUI such as, for example, the graphing GUI (300).

In the example of FIG. 3, the graphing GUI (300) displays a pop-up menu (306) in response to a user operating an input device such as, for example, clicking the right button of a mouse while the cursor is over node (304). The pop-up menu (306) includes a menu item (308) labeled ‘Properties’ for receiving a user-indication to change a node's properties, a menu item (310) labeled ‘Format’ for receiving a user-indication to change a node's format, and a menu item (312) labeled ‘Remove’ for receiving a user-indication identifying a node for removal for the visual depiction of the graph. In the example of FIG. 3, a user-indication (307) identifies a node (304) for removal from the visual depiction (309) of the graph displayed in graphing GUI (300). The node (304) to be removed has two relationships (301, 303) with one remaining node (302) after the visual depiction of the graph is simplified by removing node (304).

In the example of FIG. 3, the graphing GUI (300) also displays a visual depiction (309) of a graph having two nodes (302, 304) and having two relationships (301, 303) between the two nodes (302, 304). Readers will recall from above that the nodes and relationships of a graph may be represented in data as ASCII text that describes the graph according to an improved version of the GDL or GML for simplifying a visual depiction of a graph according to embodiments of the present invention. An example description of the graph displayed in graphing GUI (300) as visual depiction (309) using a version of the GDL improved for simplifying a visual depiction of a graph according to embodiments of the present invention may include the following description:

```
graph: {
    node: { title: “node302” display: “TRUE” }
    node: { title: “node304” display: “TRUE” }
    edge: { source: “node302” target: “node304”
        label: “edge303” display: “TRUE”}
    edge: { source: “node304” target: “node302”
        label: “edge301” display: “TRUE”}
    }
```

In the example description above, the node identified by a value of ‘node302’ for the ‘title’ attribute describes node (302). The node identified by a value of ‘node304’ for the ‘title’ attribute describes node (304). The edge identified by a value of ‘edge303’ for the ‘label’ attribute describes relationship (303). The edge identified by a value of ‘edge301’ for the ‘label’ attribute describes relationship (301). A value of ‘TRUE’ for the ‘display’ attribute indicates that each node (302, 304) and each relationship (301, 303) is displayed in the visual depiction (309) of the graph described above.

After receiving (320) a user-indication from a GUI, identifying (220) a node for removal from a visual depiction (309) of a graph according to the method of FIG. 3 may also be carried out by storing a value identifying the node identified for removal in node identifier (222). The node identifier (222) represents the node identified for removal from the visual depiction (309) of the graph. When the node identified for removal from the visual depiction (309) of the graph is described using, for example, an improved version of the GDL for simplifying a visual depiction of a graph according to embodiments of the present invention, the value stored in the node identifier (222) that identifies the node identified for removal is the value of the ‘title’ attribute in the GDL description of the node identified for removal. When the node identified for removal from the visual depiction (309) of the graph is described using, for example, an improved version of the GML for simplifying a visual depiction of a graph according to embodiments of the present invention, the value stored in the node identifier (222) that identifies the node identified for removal is the value of the ‘id’ attribute in the GML description of the node identified for removal. Using the example description above of the graph displayed in graphing GUI (300) as visual depiction (309), storing a value identifying the node identified for removal in node identifier (222) may be carried out by storing a value of ‘node304’ in the node identifier (222).

The method of Figure of 3 also includes removing (224) the node identified for removal. Removing (224) the node identified for removal may be carried out by storing, in an attribute of a node identified for removal by node identifier (222), a value representing that the node is not displayed in a visual depiction of the graph of the node. Continuing with the example description above of the graph displayed in graphing GUI (300) as visual depiction (309), storing, in an attribute of a node identified for removal by node identifier (222), a value representing that the node is not displayed in a visual depiction of the graph of the node may be carried out by storing a value of ‘FALSE’ in the ‘display’ attribute of the node (304) identified by a value of ‘node304’ in the ‘title’ attribute.

Removing a node identified for removal leaves the relationships having the node as an endpoint depicted with, at most, only one endpoint. Removing (224) the node identified for removal according to the method of FIG. 3 may therefore also be carried out by storing, in an attribute of a relationship having the node identified by node identifier (222) as an endpoint, a value representing that the relationship is not displayed in a visual depiction of the graph of the relationship. For an example, consider again the example description above of the graph displayed in the graphing GUI (300) as visual depiction (309). Storing, in an attribute of a relationship having the node identified by node identifier (222) as an endpoint, a value representing that the relationship is not displayed in a visual depiction of the graph of the relationship may be carried out by storing a value of ‘FALSE’ in the ‘display’ attribute of the relationships (301, 303) having a value of ‘node304’ in the ‘source’ or ‘target’ attribute.

Readers will note that removing (224) the node identified for removal does not delete the node or the relationships having the node as an endpoint from the graph. Removing (224) the node identified for removal according to the example of FIG. 3 removes the node from the visual depiction of the graph—not the graph itself.

After removing (224) the node identified for removal according to the method of FIG. 3, a description of the graph with the node identified for removal removed using a version of the GDL improved for simplifying a visual depiction of a graph according to embodiments of the present invention may include the following the description:

```
graph: {
    node: { title: “node302” display: “TRUE” }
    node: { title: “node304” display: “FALSE” }
    edge: { source: “node302” target: “node304”
        label: “edge303” display: “FALSE”}
    edge: { source: “node304” target: “node302”
        label: “edge301” display: “FALSE”}
    }
```

In the example description above, a value of ‘TRUE’ for the ‘display’ attribute of the node identified by a value of ‘node302’ in the ‘title’ attribute indicates that node (302) remains displayed in a visual depiction of the graph described above. However, a value of ‘FALSE’ for the ‘display’ attribute of the node identified by a value of ‘node304’ in the ‘title’ attribute, for the ‘display’ attribute of the relationship identified by a value of ‘edge303’ in the ‘label’ attribute, and for the ‘display’ attribute of the relationship identified by a value of ‘edge301’ in the ‘label’ attribute indicate that node (304) and relationships (301, 303) are not displayed in a visual depiction of the graph described above with the node identified for removal removed.

The method of FIG. 3 also includes creating (226) a virtual relationship (230) for a remaining node (302) in dependence upon the removed node's (304) relationships (301, 303) with the remaining node (302). A virtual relationship (230) may be described using, for example, a version of the GDL improved for simplifying a visual depiction of a graph according to embodiments of the present invention. An example description of the virtual relationship (230) created for a remaining node (302) in dependence upon the removed node's (304) relationships with the remaining node (302) may include the following description:

```
edge: { source: “node302” target: “node302”
    label: “virtualedge340” removednode: “node304”
    virtual: “TRUE” display: “TRUE”}
```

In the example description above, a value of ‘TRUE’ for the ‘virtual’ attribute indicates that the relationship described is a virtual relationship. The virtual relationship is identified by a value of ‘virtualedge340’ for the ‘label’ attribute. The description indicates that the node identified by a value ‘node302’ serves as both endpoints for the relationship identified by a value of ‘virtualedge340’ for the ‘label’ attribute. A value of ‘node304’ for the ‘removednode’ attribute indicates that the relationship depends on the relationship between node (304) and node (302). A value of ‘TRUE’ for the ‘display’ attribute of the relationship indicates that the relationship is displayed in a visual depiction of the graph that includes the relationship. In the method of FIG. 3, creating (226) a virtual relationship (230) for a remaining node (302) in dependence upon the removed node's (304) relationships with the remaining node (302) may be carried out by inserting a description represented by the virtual relationship (230) into the description of a graph described using a version of the GDL improved for simplifying a visual depiction of a graph according to embodiments of the present invention.

The method of FIG. 3 also includes assigning (328) a visual attribute (332) to the virtual relationship (230) in dependence upon the removed node's (304) relationship with another node (302). A visual attribute (332) represents a characteristic of a visual depiction of a relationship or a node that provides information about a removed node or the relationships for the removed node. A visual attribute (332) may include, for example, using the style of a line in the depiction of a virtual relationship to represent the type of relationship replaced by the virtual relationship. A visual attribute (332) may also include, for example, supplemental marks, features, or characters in the depiction of a remaining node to indicate the relationship the remaining node has with the removed node. Other examples of visual attributes (332) may also be useful in simplifying a visual depiction of a graph according to embodiments of the present invention as will occur to those of skill in the art.

Assigning (328) a visual attribute (332) to the virtual relationship (230) in dependence upon the removed node's (304) relationship with another node (302) according to the method of FIG. 3 may be carried out by storing, in an attribute of a relationship having the node identified by node identifier (222) as an endpoint, a value representing a visual attribute (332). For an example, consider again the above exemplary description of the virtual relationship (230). Storing, in an attribute of a relationship having the node identified by node identifier (222) as an endpoint, a value representing a characteristic of a visual depiction of the relationship may be carried out by storing a value of ‘dashed’ in a ‘linestyle’ attribute of the example description of the virtual relationship (230). An example description of the virtual relationship (230) that includes a ‘linestyle’ attribute may include the following description:

```
edge: { source: “node302” target: “node302” label: “virtualedge340”
    linestyle: “dashed” removednode: “node304”
    virtual: “TRUE” display: “TRUE”}
```

The example description above describes a virtual relationship identified by a value of ‘virtualedge340’ for the ‘label’ attribute. A value of ‘dashed’ for the ‘linestyle’ attribute indicates that the virtual relationship identified by a value of ‘virtualedge340’ for the ‘label’ attribute is displayed with a dashed line in a GUI displaying a visual depiction of a graph that includes the virtual relationship.

The method of FIG. 3 also includes displaying (234) the virtual relationship (230). Displaying (234) the virtual relationship (230) according to the method of FIG. 3 may be carried out by displaying the virtual relationship (230) using a GUI such as, for example, the graphing GUI (342). In the example of FIG. 3, the graphing GUI (342) displays a visual depiction (341) of the graph that may be described using a version of the GDL improved for simplifying a visual depiction of a graph according to embodiments of the present invention. An example description of the visual depiction (341) of the graph displayed in graphing GUI (342) may include the following:

```
graph: {
    node: { title: “node302” display: “TRUE” }
    node: { title: “node304” display: “FALSE” }
    edge: { source: “node302” target: “node304”
        label: “edge303” display: “FALSE”}
    edge: { source: “node304” target: “node302”
        label: “edge301” display: “FALSE”}
    edge: { source: “node302” target: “node302”
        label: “virtualedge340” removednode: “node304”
        linestyle: “dashed” display: “TRUE”}
    }
```

The example description of the visual depiction (341) of the graph displayed in graphing GUI (342) indicates that the node identified by a value of ‘node302’ for the ‘title’ attribute as node (302) and the relationship identified by a value of ‘virtualedge340’ for the ‘label’ attribute as virtual relationship (340) are displayed in the visual depiction (341) of the graph described above. The example description of the visual depiction (341) of the graph displayed in graphing GUI (342) indicates that the node identified by a value of ‘node304’ for the ‘title’ attribute as node (304), the relationship identified by a value of ‘edge303’ for the ‘label’ attribute as relationship (303), and the relationship identified by a value of ‘edge301’ for the ‘label’ attribute as relationship (301) are not displayed in the visual depiction (341) of the graph described above. The virtual relationship (340) of the visual depiction (341) of the graph displayed in graphing GUI (342) indicates that node (302) has relationships with a removed node.

In the example of FIG. 3, identifying a node for removal includes receiving a user selected node through, for example, a graphical user interface. Such cases require a user to select the node for removal often one node at a time. Identifying a node for removal from the visual depiction of the graph may also be carried out by selecting nodes for removal in dependence upon predetermined selection criteria. Predetermined selection criteria are predetermined conditions used to identify nodes for removal from a visual depiction of a graph that advantageously do not require individual node selection by a user. Predetermined selection criteria may include, for example, nodes representing particular objects, nodes having attributes of a particular value, nodes displayed at a particular location in a GUI, and so on.

For further explanation, therefore, FIG. 4 sets forth a flow chart illustrating a further exemplary method for simplifying a visual depiction of a graph according to embodiments of the present invention. The method of FIG. 4 is similar to the method of FIG. 3 in that simplifying a visual depiction of a graph according to the method of FIG. 4 includes identifying (220) a node for removal from a visual depiction (401) of a graph, removing (224) the node identified for removal, creating (226) a virtual relationship (230) for the at least one remaining node in dependence upon the removed node's relationships with the at least one remaining node, and displaying (234) the virtual relationship (230). The method of FIG. 4 differs from the method of FIG. 3 in that identifying (220) a node for removal from a visual depiction (401) of a graph includes selecting (420) nodes for removal in dependence upon predetermined selection criteria. As discussed above, predetermined selection criteria are predetermined conditions used to identify nodes for removal from a visual depiction of a graph. Predetermined selection criteria may include, for example, nodes representing particular objects, nodes having attributes of a particular value, nodes displayed at a particular location in a GUI, and so on.

Selecting (420) nodes for removal in dependence upon predetermined selection criteria according to the method of FIG. 4 may be carried out by reading predetermined selection criteria stored in computer memory. A software architect may store the predetermined selection criteria in computer memory when the graphing application generating the GUI is programmed or a user may enter predetermined selection criteria at run-time using a GUI such as, for example, the graphing GUI (400). In the example of FIG. 4, the graphing GUI (400) displays a menu (403) labeled ‘Display’ that includes a menu item (408) labeled ‘Properties’ for receiving a user-indication to change the display properties of the graphing GUI (400), a menu item (410) labeled ‘Format’ for receiving a user-indication to change display format of the graphing GUI (400), and a menu item (412) labeled ‘Criteria’ for receiving a user-indication to enter predetermined selection criteria.

After selecting (420) nodes for removal in dependence upon predetermined selection criteria, identifying (220) a node for removal from a visual depiction (401) of a graph according to the method of FIG. 4 may also be carried out by storing a value identifying the node identified for removal in node identifier (222) as discussed above with reference to FIG. 3. In the example of FIG. 4, predetermined selection criteria identifies node (404) for removal from the visual depiction (401) of the graph displayed in graphing GUI (400). The node (404) has two relationships (405, 407) with remaining nodes (402, 406).

In the example of FIG. 4, the graphing GUI (400) displays a visual depiction (401) of a graph having three nodes (402, 404, 406). The graph also includes a relationship (405) between node (402) and (404) and a relationship (407) between node (404) and node (406). The visual depiction (401) of the graph displayed in graphing GUI (400) may be described using a version of the GDL improved for simplifying a visual depiction of a graph according to embodiments of the present invention as discussed above.

Readers will recall from above that predetermined selection criteria identified node (404) for removal from the visual depiction (401) of the graph displayed in graphing GUI (400). Simplifying the visual depiction (401) of the graph displayed in graphing GUI (400) according to the method of FIG. 4 produces the simplified visual depiction (434) of the graph displayed in graphing GUI (432). Visual depiction (434) of the graph includes two nodes (402, 406). Node (404) and the relationships (405, 407) are removed from the visual depiction (434) of the graph and replaced with virtual relationship (430) between nodes (402, 406). The virtual relationship (430) of the visual depiction (434) of the graph displayed in graphing GUI (432) indicates that node (402) and node (406) have relationships with a removed node.

Readers will recall from above that removing a node identified for removal may be carried out by removing a dependent node. A dependent node represents a component of a system that is influenced by another component of the system. The influencing component of the system is represented by a node called an ‘antecedent node.’ A relationship exists between an antecedent node and a dependent node called a ‘dependency relationship.’ A dependency relationship is a directional relationship from a dependent node to an antecedent node. Examples of dependency relationships may include the relationship between steps in a manufacturing process where performing one step influences performing the next step or the relationship between software modules where the output from one software module serves as the input for another software module. Using an improved version of the GDL for simplifying a visual depiction of a graph according to embodiments of the present invention, a dependency relationship is represented using the ‘source’ and ‘target’ attribute of a relationship. The ‘source’ attribute represents the dependent node of the dependency relationship, and the ‘target’ attribute represents the antecedent node of the dependency relationship.

For further explanation, therefore, FIG. 5 sets forth a flow chart illustrating a further exemplary method for simplifying a visual depiction of a graph according to embodiments of the present invention that includes removing (520) a dependent node. The method of FIG. 5 is similar to the method of FIG. 3 in that simplifying a visual depiction of a graph according to the method of FIG. 5 includes identifying (220) a node for removal from a visual depiction (501) of a graph, removing (224) the node identified for removal, creating (226) a virtual relationship (230) for the at least one remaining node in dependence upon the removed node's relationships with the at least one remaining node, and displaying (234) the virtual relationship (230). The method of FIG. 5 differs from the method of FIG. 3 in that the node (506) identified for removal is implemented as a dependent node in a dependency relationship (514) with node (508). Dependent node (506) also has two other dependency relationships (510, 512) with nodes (504, 502).

In the method of FIG. 5, removing (224) the node identified for removal includes removing (520) the dependent node (506). Removing (520) the dependent node (506) may be carried out by storing, in an attribute of a node identified for removal by node identifier (222), a value representing that the node is not displayed in a visual depiction of the graph of the node and by storing, in an attribute of a relationship having the node identified by node identifier (222) as an endpoint, a value representing that the relationship is not displayed in a visual depiction of the graph of the relationship as discussed above with reference to FIG. 3.

In the method of FIG. 5, creating (226) a virtual relationship (230) for at least one remaining node (502, 504, 508) in dependence upon the removed node's (506) relationships with at least one remaining node (502, 504, 508) includes creating (522) a virtual relationship (230) between at least one antecedent node (508) of a dependency relationship (514) and at least one other remaining node (502, 504) in dependence upon the removed node's (506) relationship with at least one remaining node (502, 504, 508). Creating (522) a virtual relationship (230) between at least one antecedent node (508) of a dependency relationship (514) and at least one other remaining node (502, 504) in dependence upon the removed node's (506) relationship with at least one remaining node (502, 504, 508) may be carried out by inserting a description represented by the virtual relationship (230) into the description of a graph described using a version of the GDL improved for simplifying a visual depiction of a graph according to embodiments of the present invention. An example description of virtual relationship (230) created between at least one antecedent node (508) of a dependency relationship (514) and at least one other remaining node (502, 504) in dependence upon the removed node's (506) relationship with the at least one remaining node (502, 504, 508) may include the following description:

```
edge: { source: “node502” target: “node508” label: “virtualedge532”
    type: “DEPENDENCY” removednode: “node506”
    virtual: “TRUE” display: “TRUE”}
```

In the example description above, a value of ‘TRUE’ for the ‘virtual’ attribute and a value of ‘DEPENDENCY’ for the ‘type’ attribute indicate that the relationship described is a virtual dependency relationship. The virtual relationship is identified by a value of ‘virtualedge532’ for the ‘label’ attribute. The description indicates that node (502) identified by the value of ‘node502’ for the ‘source’ attribute serves as the dependent node of the virtual dependency relationship. The description indicates that node (508) identified by the value of ‘node508’ for the ‘target’ attribute serves as the antecedent node of the virtual dependency relationship. A value of ‘node506’ for the ‘removednode’ attribute indicates that the relationship depends on the relationship between node (506) and node (502) and on the relationship between node (506) and node (508). A value of ‘TRUE’ for the ‘display’ attribute of the relationship indicates that the relationship is displayed in a visual depiction of the graph that includes the relationship.

The method of FIG. 5 also includes assigning (524) a visual attribute (332) to at least one remaining node (508) in dependence upon the removed node's (506) relationship with at least one remaining node (508). Assigning (524) a visual attribute (332) to at least one remaining node (508) in dependence upon the removed node's (506) relationship with at least one remaining node (508) may be carried out by storing, in an attribute of a remaining node (508), a value representing a characteristic of a visual depiction of the remaining node (508). Consider, for example, storing a value of ‘D’ in a ‘depictionmarks’ attribute in following description of the node (508) using an improved version of the GDL for simplifying a visual depiction of a graph according to embodiments of the present invention:
node: {title: “node508” depicitonmarks: “D” display: “TRUE”}

The example description above describes a node identified by a value of ‘node508’ for the ‘title’ attribute as node (508). A value of ‘D’ for the ‘depictionmarks’ attribute indicates that the node (508) is displayed with a ‘D’ in a GUI displaying a visual depiction of a graph that includes the node. In the example of FIG. 5, the ‘D’ mark indicates that the removed node is a dependent node in a dependency relationship with the node depicted with the ‘D’ mark.

In the example of FIG. 5, the graphing GUI (500) displays a visual depiction (501) of a graph having four nodes (502, 504, 506, 508). The graph also includes a dependency relationship (516) from node (502) to (504), a dependency relationship (510) from node (504) to node (506), a dependency relationship (512) from node (502) to node (506), and a dependency relationship (514) from node (506) to node (508). The visual depiction (501) of the graph displayed in graphing GUI (500) may be described using a version of the GDL improved for simplifying a visual depiction of a graph according to embodiments of the present invention as discussed above.

In the example of FIG. 5, a user has identified node (506) for removal from the visual depiction (501) of the graph displayed in graphing GUI (500) through a mouse click on the node and a pop-up menu associated with a mouse click on the node (506). Node (506) has three relationships (510, 512, 514) with the remaining nodes (502, 504, 508). Simplifying the visual depiction (501) of the graph displayed in graphing GUI (500) according to the method of FIG. 5 produces the simplified visual depiction (538) of the graph displayed in graphing GUI (536). Visual depiction (538) of the graph includes three nodes (502, 504, 508). Node (506) and the relationships (510, 512, 514) for node (506) are removed from the visual depiction (538) and are replaced with virtual relationships (530, 532) and visual attribute (534). The virtual relationship (530) in the visual depiction (538) of the graph indicates that node (504) and node (508) have relationships with a removed node. The virtual relationship (532) indicates that node (502) and node (508) have relationships with a removed node. The visual attribute (534) indicates that node (508) is an antecedent node in a dependency relationship with the removed node.

Readers will note that the removed node in the example of FIG. 5 is an dependent node in a dependency relationship with only one antecedent node. The removed node may also be an dependent node in a dependency relationship with more than one antecedent node. For further explanation, therefore, FIG. 6 sets forth a flow chart illustrating a further exemplary method for simplifying a visual depiction of a graph according to embodiments of the present invention that includes a removed node (604) in a dependency relationship (605, 607) with two antecedent nodes (606, 608).

The method of FIG. 6 operates in the same manner as the method of FIG. 5. The method of FIG. 6 includes identifying (220) a node for removal from a visual depiction (601) of a graph, removing (224) the node identified for removal, creating (226) a virtual relationship (230) for the at least one remaining node in dependence upon the removed node's relationships with the at least one remaining node, and displaying (234) the virtual relationship (230).

In the example of FIG. 6, the graphing GUI (600) displays a visual depiction (601) of a graph having four nodes (602, 604, 606, 608). The graph also includes a dependency relationship (603) from node (602) to (604), a dependency relationship (609) from node (604) to (602), a dependency relationship (605) from node (604) to node (606), and a dependency relationship (607) from node (604) to node (608). The visual depiction (601) of the graph displayed in graphing GUI (600) may be described using a version of the GDL improved for simplifying a visual depiction of a graph according to embodiments of the present invention as discussed above.

In the example of FIG. 6, a user has identified a node (604) for removal from the visual depiction (601) of the graph displayed in graphing GUI (600) through a mouse click on the node and a pop-up menu associated with a mouse click. Node (604) has four relationships (603, 605, 607, 609) with the remaining nodes (602, 606, 608). Node (604) identified for removal is implemented as a dependent node in three dependency relationships (605, 607, 609) with three other nodes (602, 606, 608). Node (604) also has one other relationship (603) with node (602) in which the node (604) serves as an antecedent node. Simplifying a visual depiction (601) of the graph displayed in graphing GUI (600) according to the method of FIG. 6 produces the simplified visual depiction (636) of the graph displayed in graphing GUI (634). The visual depiction (636) includes three nodes (602, 606, 608).

Node (604) and the relationships (603, 605, 607, 609) for node (604) are removed from the visual depiction (636) and are replaced with virtual relationships (630, 632, 638) and visual attributes (640, 642). The virtual dependency relationship (630) indicates that node (602) and node (606) have relationships with a removed node. The virtual dependency relationship (632) indicates that node (602) and node (608) have relationships with a removed node. The virtual dependency relationship (638) indicates that node (602) has relationships with a removed node. The visual attribute (640) indicates that node (606) is an antecedent node in a dependency relationship with a removed node. The visual attribute (642) indicates that node (608) is an antecedent node in a dependency relationship with a removed node.

Readers will recall from above that removing a node identified for removal may be carried out by collapsing a node identified for removal into a containing node. A contained node is a node that represents a component of a system that is part of another component of the system. The other component of which the component is a part is represented by a node called a ‘containing node.’ A relationship exists between a containing node and a contained node called a ‘containing relationship.’ A containment relationship is a directional relationship from a containing node to a contained node. Examples of containment relationships may include the relationship between a computer processor and the computer machine containing the computer processor or the relationship between a computer software subroutine and the computer software application containing the computer software subroutine. Using an improved version of the GDL for simplifying a visual depiction of a graph according to embodiments of the present invention, a containment relationship is represented using the ‘source’ and ‘target’ attribute of a relationship. The ‘source’ attribute represents the containing node of the containment relationship, and the ‘target’ attribute represents the contained node of the containment relationship.

For further explanation, therefore, FIG. 7 sets forth a flow chart illustrating a further exemplary method for simplifying a visual depiction of a graph according to embodiments of the present invention that includes collapsing (720) a node identified for removal into a containing node. The method of FIG. 7 is similar to the method of FIG. 3 in that simplifying a visual depiction of a graph according to the method of FIG. 5 includes identifying (220) a node for removal from a visual depiction (501) of a graph, removing (224) the node identified for removal, creating (226) a virtual relationship (230) for the at least one remaining node in dependence upon the removed node's relationships with the at least one remaining node, and displaying (234) the virtual relationship (230). The method of FIG. 5 differs from the method of FIG. 7 in that the node (706) identified for removal is implemented as a contained node in a containment relationship (712) with a containing node (702).

In the method of FIG. 7, removing (224) the node identified for removal includes collapsing (720) the node (706) identified for removal into the containing node (702). Collapsing (720) the node (706) identified for removal into the containing node (702) may be carried out by storing, in an attribute of a node (706) identified for removal by node identifier (222), a value representing that the node is not displayed in a visual depiction of the graph of the node (706) and by storing, in an attribute of relationships (710, 712, 714) having the node (706) identified by node identifier (222) as an endpoint, a value representing that the relationships (710, 712, 714) are not displayed in a visual depiction of the graph of the relationships (710, 712, 714) as discussed above with reference to FIG. 3.

In the method of FIG. 7, creating (226) a virtual relationship (230) for the remaining nodes (702, 704, 708) in dependence upon the removed node's (706) relationships with the remaining nodes (702, 704, 708), creating (722) a virtual relationship (230) between the containing node (702) and at least one other remaining node (704, 708) in dependence upon the removed node's (706) relationship with the remaining nodes (702, 704, 708). Creating (722) a virtual relationship (230) between the containing node (702) and at least one other remaining node (704, 708) in dependence upon the removed node's (706) relationship with the remaining nodes (702, 704, 708) may be carried out by inserting a description represented by the virtual relationship (230) into the description of a graph described using a version of the GDL improved for simplifying a visual depiction of a graph according to embodiments of the present invention.

In the example of FIG. 7, the graphing GUI (700) displays a visual depiction (701) of a graph having four nodes (702, 704, 706, 708). The graph also includes a containment relationship (712) from node (702) to (706), a dependency relationship (703) from node (702) to node (704), a dependency relationship (710) from node (704) to node (706), and a dependency relationship (714) from node (706) to node (708). The visual depiction (701) of the graph displayed in graphing GUI (700) may be described using a version of the GDL improved for simplifying a visual depiction of a graph according to embodiments of the present invention as discussed above.

In the example of FIG. 7, a user has identified a node (706) for removal from the visual depiction (701) of the graph displayed in graphing GUI (700) though a mouse click on the node and a pop-up menu associated with a mouse click. Node (706) has three relationships (710, 712, 714) with the remaining nodes (702, 704, 708). Simplifying a visual depiction (701) of the graph displayed in graphing GUI (700) according to the method of FIG. 7 produces the simplified visual depiction (736) displayed in graphing GUI (734). Visual depiction (736) of the graph includes three nodes (702, 704, 708). Node (706) and the relationships (710, 712, 714) for node (706) are removed from the visual depiction (736) and are replaced with virtual relationships (730, 732) and visual attribute (734). The virtual relationship (730) indicates that node (704) and node (702) have relationships with a removed node. The virtual relationship (732) indicates that node (702) and node (708) have relationships with a removed node. The visual attribute (734) indicates that node (702) is a containing node in a containment relationship with a removed node.

Readers will note from the visual depiction (736) that the virtual relationships (730, 732) created according to the method of FIG. 7 are virtual dependency relationships. The types of virtual relationships created are the same types as the relationship between the removed node (706) and the remaining nodes (704, 708) into which the removed node (706) is not collapsed. That is, virtual relationships created are virtual dependency relationships because the relationships (710, 714) between the removed node (706) and the nodes (704, 708) are dependency relationships. Creating a virtual dependency relationship, however, is for explanation and not for limitation. In fact, creating (226) a virtual relationship (230) for the remaining nodes in dependence upon the removed node's relationships with the remaining nodes may create virtual relationships of other types such as, for example, back relationships, near relationships, or any other type of relationship as will occur to those of skill in the art.

Readers will recall that the visual depiction (501) of the graph displayed in graphing GUI (500) in the example of FIG. 5 is similar to the visual depiction (701) of the graph displayed in graphing GUI (700) in the example of FIG. 7. In the example of FIG. 5, however, the relationship (512) for the node (506) identified for removal is a dependency relationship, while in the example of FIG. 7, the relationship (712) for the node (706) identified for removal is a containment relationship. Readers will note that the different type of relationships for the nodes identified for removal in the examples of FIGS. 5 and 7 produce slightly different virtual relationships (530, 730) in the simplified visual depictions (538, 736) of the graphs. In the example of FIG. 5, the dependency relationship from node (502) to node (506) results in a virtual dependency relationship (530) from node (504) to node (508). In the example of FIG. 7, the containment relationship from node (702) to node (706) results in a virtual dependency relationship (730) from node (704) to node (702).

Exemplary embodiments of the present invention are described largely in the context of a fully functional computer system for simplifying a visual depiction of a graph. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for simplifying a visual depiction of a graph, the method comprising:
identifying a node for removal from the visual depiction of the graph, the node having at least two relationships with at least one remaining node;
removing the node identified for removal;
creating a virtual relationship for the at least one remaining node in dependence upon the removed node's relationships with the at least one remaining node; and
displaying the virtual relationship.

2. The method of claim 1 wherein:
the node identified for removal is a contained node in a containment relationship with a containing node;
removing the node identified for removal further comprises collapsing the node identified for removal into the containing node; and
creating a virtual relationship for at least one of the remaining nodes in dependence upon the removed node's relationships with the at least one remaining node further comprises creating a virtual relationship between the containing node and at least one other remaining node in dependence upon the removed node's relationship with the at least one remaining node.

3. The method of claim 1 wherein:
the node identified for removal is a dependent node in a dependency relationship with at least one other node and the node to be removed has at least one other relationship with at least one other node;
removing the node identified for removal further comprises removing the dependent node; and
creating a virtual relationship for at least one of the remaining nodes in dependence upon the removed node's relationships with the at least one remaining node further comprises creating a virtual relationship between at least one antecedent node of the dependency relationship and at least one other remaining node in dependence upon the removed node's relationship with the at least one remaining node.

4. The method of claim 1 further comprising assigning a visual attribute to the virtual relationship in dependence upon the removed node's relationship with at least one other node.

5. The method of claim 1 further comprising assigning a visual attribute to the at least one remaining node in dependence upon the removed node's relationship with the at least one remaining node.

6. The method of claim 1 wherein identifying a node for removal from the visual depiction of the graph, the node having at least two relationships with one or more other nodes, further comprising selecting nodes for removal in dependence upon predetermined selection criteria.

7. The method of claim 1 wherein the virtual relationship is a new relationship with the at least one remaining node that retains information about the removed node's relationships with the at least one remaining node.

8. The method of claim 1 wherein displaying the virtual relationship further comprises displaying an arrow representing the virtual relationship.

9. An apparatus for simplifying a visual depiction of a graph, the apparatus comprising a computer processor, a computer memory operatively coupled to the computer processor, the computer memory having disposed within it computer program instructions capable of:
identifying a node for removal from the visual depiction of the graph, the node having at least two relationships with at least one remaining node;
removing the node identified for removal;
creating a virtual relationship for the at least one remaining node in dependence upon the removed node's relationships with the at least one remaining node; and
displaying the virtual relationship.

10. The apparatus of claim 9 wherein:
the node identified for removal is a contained node in a containment relationship with a containing node;
removing the node identified for removal further comprises collapsing the node identified for removal into the containing node; and
creating a virtual relationship for at least one of the remaining nodes in dependence upon the removed node's relationships with the at least one remaining node further comprises creating a virtual relationship between the containing node and at least one other remaining node in dependence upon the removed node's relationship with the at least one remaining node.

11. The apparatus of claim 9 wherein:
the node identified for removal is a dependent node in a dependency relationship with at least one other node and the node to be removed has at least one other relationship with at least one other node;
removing the node identified for removal further comprises removing the dependent node; and
creating a virtual relationship for at least one of the remaining nodes in dependence upon the removed node's relationships with the at least one remaining node further comprises creating a virtual relationship between at least one antecedent node of the dependency relationship and at least one other remaining node in dependence upon the removed node's relationship with the at least one remaining node.

12. The apparatus of claim 9 further comprising computer program instructions capable of assigning a visual attribute to the virtual relationship in dependence upon the removed node's relationship with at least one other node.

13. The apparatus of claim 9 wherein identifying a node for removal from the visual depiction of the graph, the node having at least two relationships with one or more other nodes, further comprising selecting nodes for removal in dependence upon predetermined selection criteria.

14. The apparatus of claim 9 wherein displaying the virtual relationship further comprises displaying an arrow representing the virtual relationship.

15. A computer program product for simplifying a visual depiction of a graph, the computer program product disposed upon a signal bearing medium, the computer program product comprising computer program instructions capable of:
identifying a node for removal from the visual depiction of the graph, the node having at least two relationships with at least one remaining node;
removing the node identified for removal;
creating a virtual relationship for the at least one remaining node in dependence upon the removed node's relationships with the at least one remaining node; and
displaying the virtual relationship.

16. The computer program product of claim 15 wherein the signal bearing medium comprises a recordable medium.

17. The computer program product of claim 15 wherein the signal bearing medium comprises a transmission medium.

18. The computer program product of claim 15 wherein:
the node identified for removal is a contained node in a containment relationship with a containing node;
removing the node identified for removal further comprises collapsing the node identified for removal into the containing node; and
creating a virtual relationship for at least one of the remaining nodes in dependence upon the removed node's relationships with the at least one remaining node further comprises creating a virtual relationship between the containing node and at least one other remaining node in dependence upon the removed node's relationship with the at least one remaining node.

19. The computer program product of claim 15 wherein:
the node identified for removal is a dependent node in a dependency relationship with at least one other node and the node to be removed has at least one other relationship with at least one other node;
removing the node identified for removal further comprises removing the dependent node; and
creating a virtual relationship for at least one of the remaining nodes in dependence upon the removed node's relationships with the at least one remaining node further comprises creating a virtual relationship between at least one antecedent node of the dependency relationship and at least one other remaining node in dependence upon the removed node's relationship with the at least one remaining node.

20. The computer program product of claim 15 wherein identifying a node for removal from the visual depiction of the graph, the node having at least two relationships with one or more other nodes, further comprising selecting nodes for removal in dependence upon predetermined selection criteria.
